(19) United States
(12) Patent Application Publication
(10) Pub. No.: US 2007/0260542 A1
(43) Pub. Date: Nov. 8, 2007

(54) Distributed transaction processing system and method thereof

(75) Inventor: Ta-Hsiung Hu, Taipei (TW)

Correspondence Address: BACON & THOMAS, PLLC, 625 SLATERS LANE, FOURTH FLOOR, ALEXANDRIA, VA, 22314, US

(73) Assignee: Kinghood Technology Co., Ltd., Taipei (TW)

(21) Appl. No.: 11/429,143

(22) Filed: May 8, 2006

(51) Int. Cl. G06Q 40/00

(52) U.S. Cl. 705/44

(57) ABSTRACT

A distributed transaction processing system with classified data of specialized transaction and a method thereof are disclosed. The method of distributed transaction processing system having an authorization computer and at least a computer workgroup, includes the steps of a) initializing a distributed transaction processing system of the computer workgroup, wherein the computer workgroup further includes at least a professional computer; b) inputting a sign-on information; c) obtaining an identifying information and a related code name of the computer workgroup according to the sign-on information; d) verifying the identifying information with the sign-on information; e) connecting to the computer workgroup according to the related code name thereof; f) issuing a request; and g) dispatching the request to the professional computer for proceeding and executing, thereby simplifying the transaction process and increasing the efficiency and extendibility of the entire system.

### FIELD OF THE INVENTION

The present invention relates to a distributed transaction processing system and a method thereof, and more particularly, to a distributed transaction processing system with classified data of specialized transaction and a method thereof, thereby increasing the efficiency and extendibility of the entire system.

### BACKGROUND OF THE INVENTION

In recent years, the Internet distributed computer network has developed the infrastructure and data communications protocols to connect to each other regardless of their size, geographic location or position in the supply chain. The Internet is a collection of interconnected individual networks operated by government, industry, academia, and private parties that use a set of standard data communications protocols to form a global, distributed network. Networked distributed computer systems may be configured as intranets, extranets or publicly available systems using Internet technologies.

Traditionally, and for a long time, the control and management of transaction data have been carried out by means of centralized mainframe computers. These machines were initially accessible locally, then later through networks which became increasingly complex, but were still hierarchical. As shown in FIG. 1, it illustrates a server as a centralized mainframe computer for all users according the prior art. The server 11 is set on Intranet and all users 12 should login to the server 11 and load the database 13 via the server 11. Obviously, the system is limited by Intranet, and outer users 14 could not apply to use the database 13 via the server 11. In a multi user data processing environment, some sort of concurrency control is needed in order to avoid problems when two or more users attempt to update a field of a record in the database on the basis of an initial value of that field. One approach to concurrency control is known as locking. Another is known as time-stamping or optimistic concurrency control. Of the two, locking is the more important as it is the method that is predominantly used.

Furthermore, more and more companies transform their Intranet as Web-based mainframe for integrating with Internet, Extranet and other outer database. As shown in FIG. 2, it illustrates a centralized mainframe server for several clients according the prior art. There is a centralized server 21 connected with a centralized database 22. Meanwhile, several clients, such as the inner computers 23 of the company, the outer computer 24, the branched computer 25 of the company, or other on-line apparatus 26, are connected to the centralized server 21, and are able to apply the centralized database 22 via the centralized server 21. A transaction can obtain a lock on a record by issuing a request to a system component called the lock manager of the centralized server 21. If a transaction holds an exclusive lock on some object, say, a database record, then no other transaction can acquire a lock of any type on that object until the first transaction releases its lock. Any transaction that intends to update a record must first acquire a lock on it. If a lock cannot be acquired, the transaction is blocked and goes into a wait state. The transaction is restarted when the record becomes available and the lock can be granted. While this locking protocol solves the lost update problem, it introduces two others. One is the problem of deadlock, in which two or more transactions are in a simultaneous wait state, each waiting for the others to release a lock required for it to proceed. The other problem, which can be encountered in high performance applications is that many or even most of these transactions can be waiting at a given time, even without the presence of deadlock. Increasing the level of concurrency can actually reduce the number doing useful work at a given time.

Generally, a distributed management environment makes it possible to integrate the administration of systems, networks and user applications, the dialogue between the various machines of the system and/or between the various users being organized around requests and responses to these requests, the most common requests in a network being related to file access or data access. The problem of deadlock has been extensively studied. In general, the lock manager must be capable of detecting the occurrence of deadlocks and resolve them. Resolving the deadlock amounts to choosing one of the locked transactions and rolling it back. This process involves terminating the transaction and undoing all its updates and releasing its locks so that the resources concerned can be allocated to other transactions.

The most commonly used approach to distributed concurrency control is to use the standard centralized locking method at each node for all subtransactions running at that node. Each subtransaction of a given transaction holds all locks it acquires until all subtransactions signal completion, after which a commit protocol is followed for recovery purposes. All locks are then released by each subtransaction as part of the completion of the commit protocol. Distributed deadlock detection is a known problem under this approach, and a variety of techniques are known to deal with it. A more serious problem is that the level of data contention is likely to be significantly higher than that of a centralized system with similar total processing power and with a similar transaction processing workload, for the following reasons. First, compared to the centralized system, there are additional delays for each transaction due to communication among subtransactions during execution and during the commit phase, resulting in increased lock holding times. Second, the total number of processors in the distributed system could be significantly larger than in the centralized case, thus requiring a higher total level of concurrency just to utilize the processors.

The trend towards longer and more complex transactions supported by distributed systems substantially increases the amount of data contention, which could limit the total available throughput. Furthermore, in practice, it is known that the usual locking methods of concurrency control are not well suited to environments where data contention is a significant factor. On the other hand, it is difficult to implement. Hence, it needs to provide a distributed transaction processing system and a method thereof, which provides a classified data of specialized transaction for simplifying the transaction process, is capable of increasing the efficiency and extendibility of the entire system, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a distributed transaction processing system with a classified data of specialized transaction for simplifying the transaction process, is capable of increasing the efficiency and extendibility of the entire system, and can rectify those drawbacks of the prior art and solve the above problems.

In accordance with an aspect of the present invention, the distributed transaction processing system includes at least an authorization computer for identifying a sign-on information of a user; and at least a computer workgroup connected to the authorization computer, wherein the computer workgroup further includes at least a database for storing a related information of the computer workgroup; at least a professional computer; and at least an application-program (AP) server for receiving a request from the user and dispatching the request to related one of the professional computer for executing in response to the request, wherein the authorization computer dispatches the computer workgroup in response to the sign-on information of the user, and the AP server further informs other AP server of other related computer workgroup to execute the request while the request has to access the database of the other related computer workgroup.

Preferably, the professional computer includes at least a download server for replying a download request.

Preferably, the professional computer includes at least a communication server for replying an on-time communication request or pushing an information message to the associated on-line user, in which the information message could be an email message or a message for event notice, or a short message, etc.

Certainly, the authorization computer and the computer workgroup can be connected via Internet.

Preferably, the authorization computer and the computer workgroup are connected via Intranet.

Certainly, the computer workgroups can be connected with each other via Internet.

Preferably, the computer workgroups are connected with each other via Intranet.

Preferably, the authorization computer further includes a Sign-on, Identify and Authorize module for identifying the sign-on information of the user.

Preferably, the authorization computer further includes a dispatch module for dispatching the request to related one of the professional computer.

Preferably, the database, the professional sever and the AP server further includes a Data Encode and Decode module for protecting data thereof.

Preferably, the AP server further includes a procedure-call interface for communicating with each other.

It is another object of the present invention to provide a distributed transaction processing method for simplifying the transaction process, is capable of increasing the efficiency and extendibility of the entire system, and can rectify those drawbacks of the prior art and solve the above problems.

In accordance with the aspect of the present invention, the distributed transaction processing method includes the steps of a) initializing a distributed transaction processing system comprising at least a computer workgroup, wherein the computer workgroup further comprises at least a professional computer; b) inputting a sign-on information; c) obtaining an identifying information and a related code name of the computer workgroup according to the sign-on information; d) verifying the identifying information with the sign-on information; e) connecting to the computer workgroup according to the related code name thereof; f) issuing a request; and g) dispatching the request to the professional computer for proceeding and executing.

Certainly, the step d) can be repeated to be executed in an anticipated period.

Preferably, the step e) further includes the step of e1) dispatching an application-program (AP) server in response to the identifying information.

Preferably, the distributed transaction processing method further includes the steps of h) connecting to another computer workgroup; i)transmitting the request to the another computer workgroup; and j) dispatching the request to a professional computer of the another computer workgroup for proceeding and executing.

Preferably, the step h) further includes the step of h1) dispatching an application-program (AP) server of the other computer workgroup in response to the request.

Certainly, the identifying information and the related code name of the computer workgroup can be stored in an authorization computer.

Preferably, the step e) further includes the step of e2) transmitting a verified result of the sign-on information and the identifying information.

Preferably, the authorization computer further includes a Sign-on, Identify and Authorize module for identifying the sign-on information.

Preferably, the distributed transaction processing method further includes the step of k) replying a result information after the request has been proceeded and executed.

Preferably, the distributed transaction processing method further includes the step of l) storing the result information into a database of the computer workgroup.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates a server as a centralized mainframe computer for all users according the prior art;

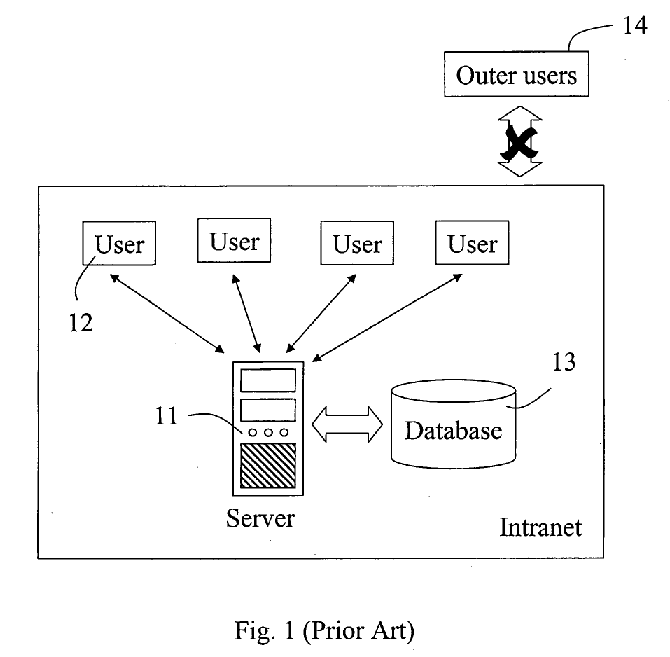

FIG. 2 illustrates a centralized mainframe server for several clients according the prior art;

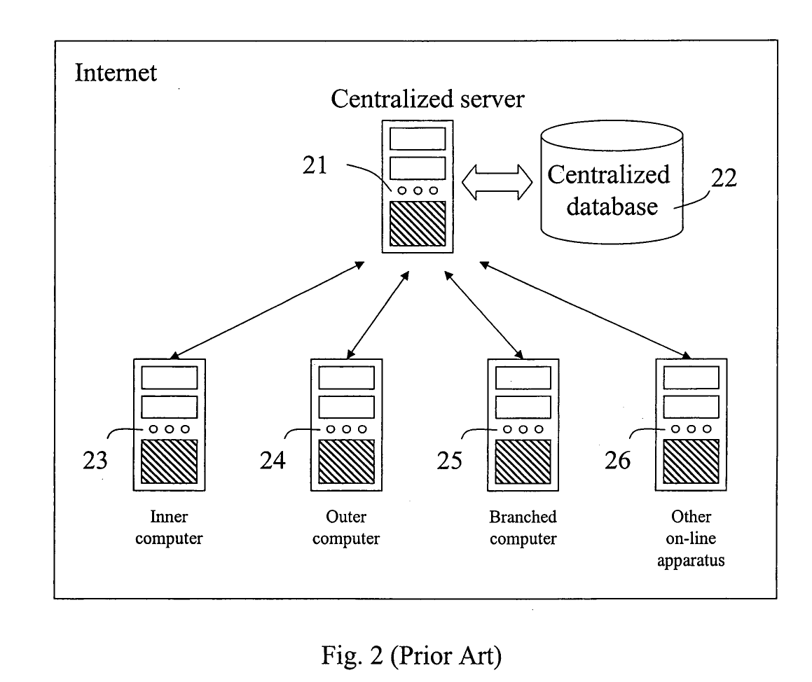

FIG. 3 illustrates a preferred embodiment of a distributed transaction processing system according to the present invention;

FIG. 4 illustrates another preferred embodiment of a distributed transaction processing system according to the present invention

FIG. 5 illustrates a preferred embodiment of a distributed transaction processing method according to the present invention; and

FIG. 6 illustrates another preferred embodiment of a distributed transaction processing method according to the present invention.

### DETAILED DESCRIPTION OF THE PREFERRED EMBODIMENT

The present invention discloses a distributed transaction processing system with classified data of specialized transaction and a method thereof, and the objects and advantages of the present invention will become more readily apparent to those ordinarily skilled in the art after reviewing the following detailed description. The present invention needs not be limited to the following embodiment.

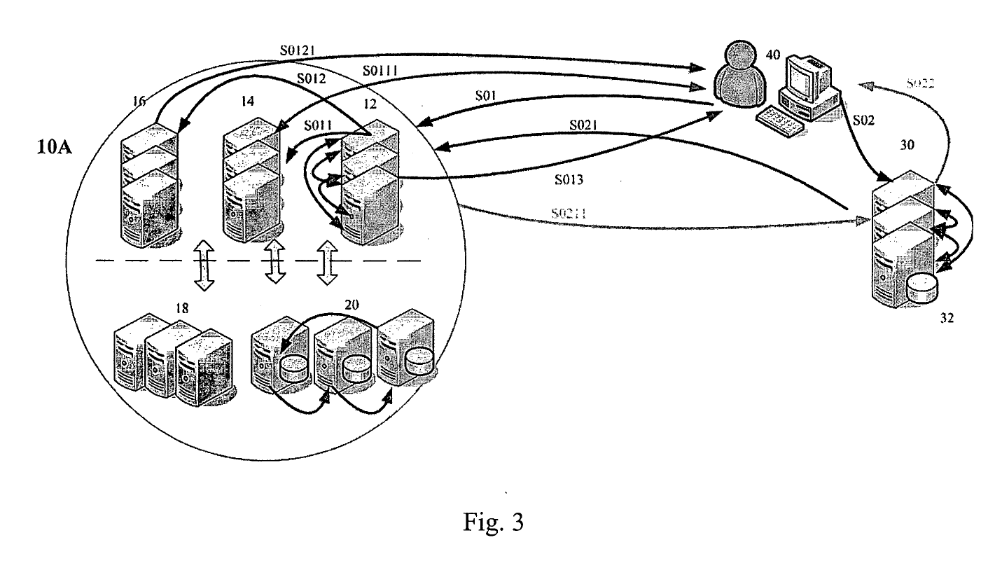

Please refer to FIG. 3. It illustrates a preferred embodiment of a distributed transaction processing system according to the present invention. As shown in FIG. 3, the distributed transaction process system includes at least an authorization computer 30 for identifying a sign-on information of a user 40; and at least a computer workgroup 10A connected to the authorization computer 30, wherein the computer workgroup 10A further includes at least a database 20 for storing a related information of the computer workgroup 10A; at least a professional computer 14, 16 or 18; and at least an application-program (AP) server 12 for receiving a request from the user 40 and dispatching the request to related one of the professional computer 14, 16, or 18 for executing in response to the request, wherein the authorization computer 30 dispatches the computer workgroup 10A in response to the sign-on information of the user 40.

In practice, the user could connect to the authorization computer 30 from any place via several types (i.e. Internet or Intranet), as shown in procedure S02. A sign-in information (such as user name or password) of the user 40 is verified with an identifying information of the authorization computer 30, wherein the identifying information is classified and stored in the authorization computer 30. After verifying, as shown in procedure S01 and S021, the user 40 is connected to the AP server 12 of the computer workgroup 10A according to the identifying information, which is classified in response to the user 40 and stored in the authorization computer 30. Then the AP server 12 is in charge of replying a request from the user 40. If the sign-on information from the user 40 is not able to achieve the verifying process, as shown in procedure S022, the dispatching step will not be activated and the authorization computer 30 will reply “login failed”.

When the user 40 issues a request to the AP server 12, the AP server 12 will determine to reply the request of the user 40 (procedure S013) or transmit the request to other professional computer, such as a communication server 14, a download server 16, a mail server 18, or the other professional servers to proceed and execute (procedures S011, S012). After receiving the request from the user 40, the professional computer will connect directly to the user 40, perform the related request, and reply directly the result to the user 40 instead of replying via the AP server 12, wherein all proceeding records are stored in the database 20 of the computer workgroup 10A.

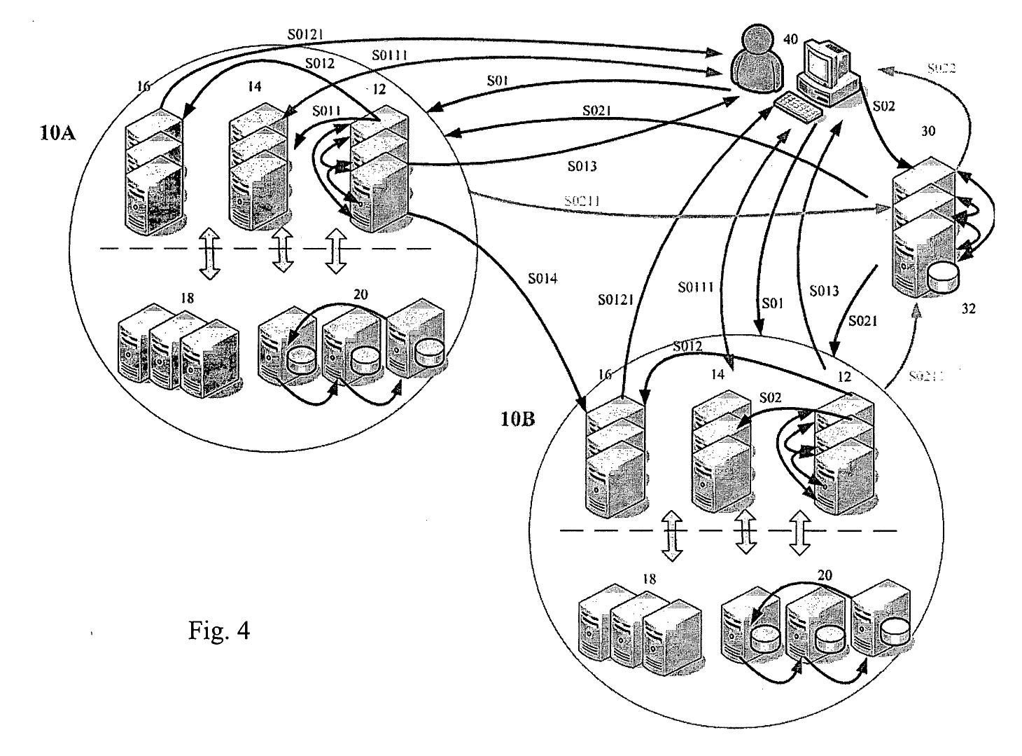

Please refer to FIG. 4. It illustrates another preferred embodiment of a distributed transaction processing system according to the present invention. As shown in FIG. 4, the distributed transaction process system includes at least an authorization computer 30 for identifying a sign-on information of a user 40; and at least two computer workgroups 10A and 10B connected to the authorization computer 30, wherein each of the computer workgroups 10A and 10B further includes at least a database 20 for storing a related information of the computer workgroup 10A; at least a professional computer 14, 16 or 18; and at least an application-program (AP) server 12 for receiving a request from the user 40 and dispatching the request to related one of the professional computer 14, 16, or 18 for executing in response to the request, wherein the authorization computer 30 dispatches the computer workgroup 10A in response to the sign-on information of the user 40, and the AP server 12 further informs other AP server 12 of other related computer workgroup 10B to execute the request while the request has to access the database 20 of the other related computer workgroup 10B.

As we know, Distributed Transaction Processing (DTP) is a form of on-line transaction processing that allows a single transaction to be performed by multiple application programs that access one or more databases on one or more computers across a network. This type of transaction, in which multiple application programs cooperate, is called a distributed transaction. Using DTP, for example, related databases at regional and branch locations can be synchronized. DTP also facilitates transaction processing across multiple enterprises. For example, DTP can be used to coordinate the computers of manufactures and suppliers, or to coordinate the computers of enterprises in related industries, such as the travel agency, airline, car rental, and hotel industries. According to FIG. 4, the user could connect to the authorization computer 30 from any place via several types (i.e. Internet or Intranet), as shown in procedure S02. A sign-in information (such as user name or password) of the user 40 is verified with an identifying information of the authorization computer 30, wherein the identifying information is classified and stored in the authorization computer 30. After verifying, as shown in procedure S01 and S021, the user 40 is connected to the AP server 12 of the computer workgroup 10A according to the identifying information, which is classified in response to the user 40 and stored in the authorization computer 30. Then the AP server 12 is in charge of replying a request from the user 40. If the sign-on information from the user 40 is not able to achieve the verifying process, as shown in procedure S022, the dispatching step will not be activated and the authorization computer 30 will reply “login failed”.

Furthermore, if the user 40 issues a new request, which should be executed on other computer workgroup 10B, to the AP server 12 of the computer workgroup 10A, the AP server 12 of the computer workgroup 10A will dispatch the new request to the AP server 12 of the computer workgroup 10B, as shown in the procedure S014. Furthermore, each professional server, such as a communication server 14 or a download server 16, could communicate with the user 40, as shown in the procedures S0121 and S0111. In this embodiment, the communication server 14 and the user 40 communicate with each other in bi-directional communication for replying the on-time request of the user 40, but the download server 16 supply one-way download service in response to the request of the user 40. In procedures S0211 and S021, the system of the present invention will repeat to verify the identifying information of authorization computer 30 with the sign-on information of the user 40 in each anticipated period for confirming whether the user 40 is still in on-line status, thereby preventing the identity of the user 40 from being misappropriated. When the authorization computer 30 find that the user 40 is not in on-line status or the identity of the user is misappropriated, the authorization computer 30 will cut off the on-line status of the user 40 for protecting the security of the entire system.

Accordingly, the amount of distributed servers could be increased independently, and the authorization computer and the AP servers could dispatch transaction request according to the loading of every servers for keeping all servers of the system performed in the optimum state. Certainly, the authorization computer further includes a dispatch module for dispatching the request to related one of the professional computers. Furthermore, in the system of the present invention, the authorization computer further includes a Sign-on, Identify and Authorize module for identifying the sign-on information of the user; the database, the professional sever and the AP server further includes a Data Encode and Decode module for protecting data thereof; and the AP server further includes a procedure-call interface for communicating with each other.

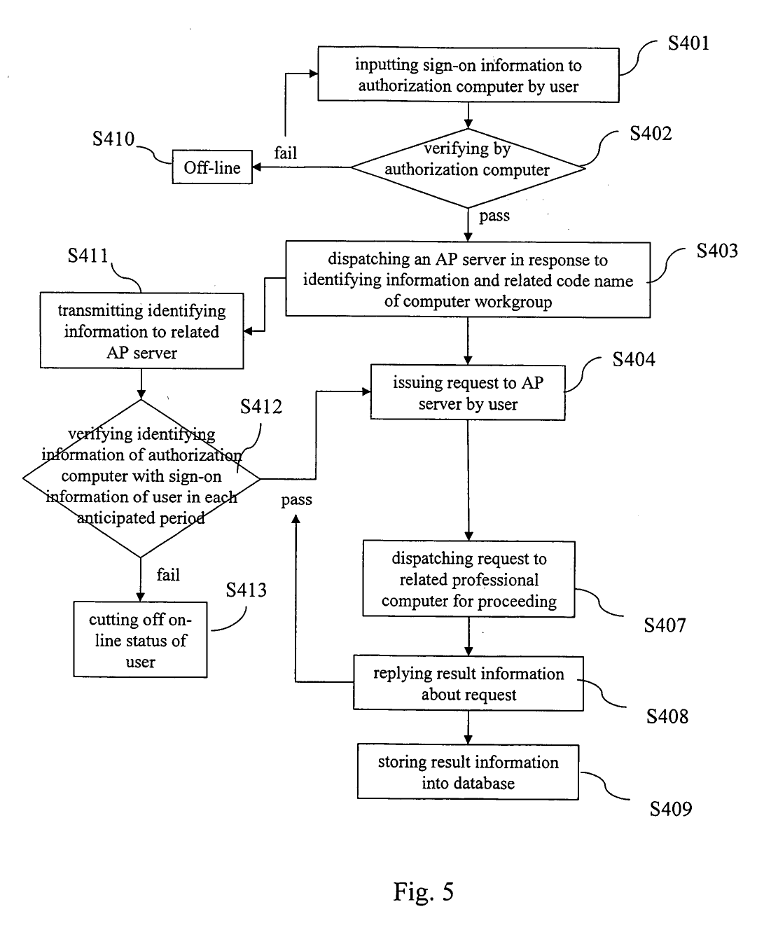

It is another object of the present invention to provide a method to provide a distributed transaction processing method, as shown in FIG. 5. Meanwhile, the distributed transaction processing method includes the steps of a) initializing a distributed transaction processing system comprising at least a computer workgroup, wherein the computer workgroup 10A further comprises at least a professional computer (Please refer to FIG. 3); b) inputting a sign-on information, as shown in the procedure S401; c) obtaining an identifying information and a related code name of the computer workgroup according to the sign-on information, wherein the identifying information and the related code name of the computer workgroup are stored in an authorization computer; d) verifying the identifying information with the sign-on information, as shown in the procedure S402; e) connecting to the computer workgroup according to the related code name thereof, as shown in the procedure S403; f) issuing a request, as shown in the procedure S404; and g) dispatching the request to the professional computer for proceeding and executing, as shown in the procedure S407.

In practice, the step d) is repeated to be executed in an anticipated period for preventing the identity of the user from being misappropriated. (Please also refer to the procedures S0211 and S021 in FIG. 3). If it is fail to verify the sign-on information by the authorization computer, the user has to repeat the procedure S401 or off-line as shown in the procedure S410. Furthermore, the step e) further includes the step of e1) dispatching an application-program (AP) server in response to the identifying information for replying the request of the user (as shown in the procedure S013 of FIG. 3).

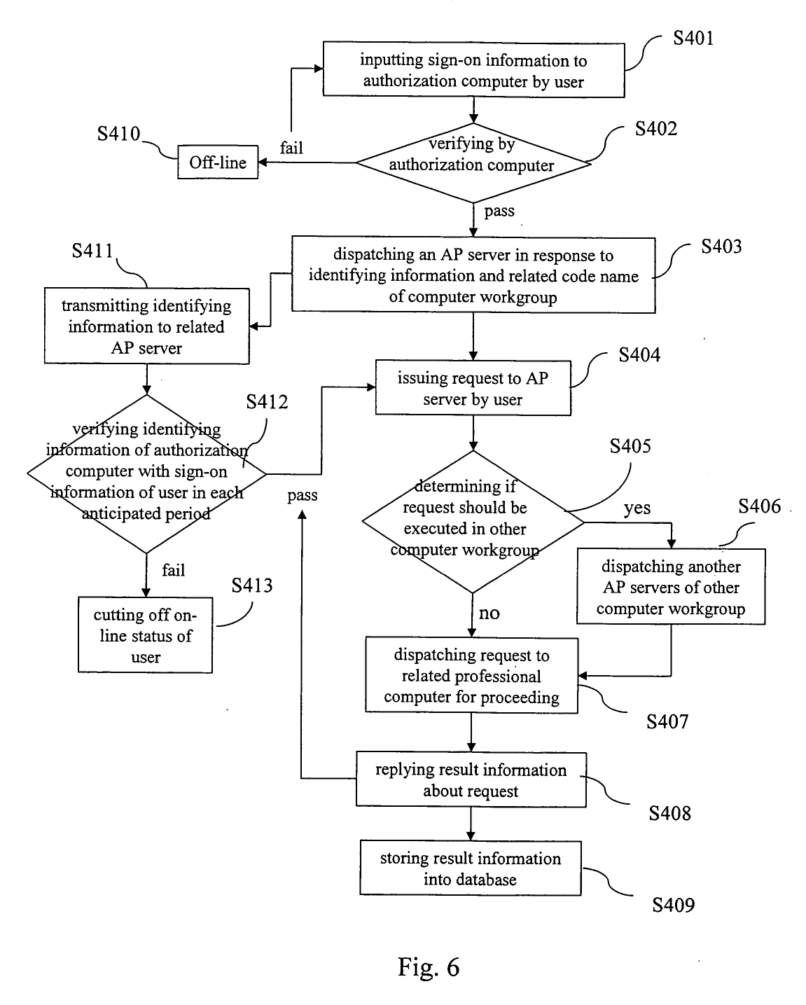

Certainly, the distributed transaction processing system of the present invention could includes at least two computer workgroups 10A and 10B, as shown in FIG. 4. Accordingly, the distributed transaction processing method, shown in FIG. 6, further includes the steps of h) connecting to other computer workgroup; i) transmitting the request to the other computer workgroup; and j) dispatching the request to a professional computer of the other computer workgroup for proceeding and executing, wherein those steps are illustrated as the procedures from S405 to S406 and S407 in FIG. 6. If the user issues a new request, which should be executed on other computer workgroup 10B (Please refer to FIG. 4), to the AP server of the original computer workgroup, the AP server of the original computer workgroup will dispatch the new request to the AP server of the other computer workgroup 10B, also shown in the procedure S014 of FIG. 4. Meanwhile, the step h) further includes the step of hi) dispatching an application-program (AP) server of the other computer workgroup 10B in response to the request of the user. On the other hand, the system of the present invention will repeat to verify the identifying information of authorization computer with the sign-on information of the user in each anticipated period for confirming whether the user is still in on-line status. The authorization computer transmits the identifying information to related AP server, as shown in the procedure S411, and then the AP server verify the identifying information of the authorization computer with sign-on information of user in each anticipated period, as shown in the procedure S412. Therefore, the step e) further includes the step of e2) transmitting a verified result of the sign-on information and the identifying information. If the AP server fails to verify the identifying information of the authorization computer with sign-on information of user, the system will cut off on-line status of the user for protecting the security of the entire system, as shown in the procedure S413. Moreover, the distributed transaction processing method further includes the step of k) replying a result information after the request has been proceeded and executed for informing the user, as shown in the procedure S408, and includes the step of l) storing the result information into a database of the computer workgroup, as shown in the procedure S409. Thus, the distributed transaction processing system and the method of the present invention could support flexible and efficient processing options in a network environment.

In conclusion, the present invention provides a distributed transaction processing system and a method thereof, which provides a classified data of specialized transaction for simplifying the transaction process, is capable of increasing the efficiency and extendibility of the entire system, and can rectify those drawbacks of the prior art and solve the above problems. Meanwhile the prior art fail to disclose that. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A distributed transaction processing system, comprising:
at least an authorization computer for identifying a sign-on information of a user; and
at least a computer workgroup connected to said authorization computer, wherein said computer workgroup further comprises:
at least a database for storing a related information of said computer workgroup;
at least a professional computer; and
at least an application-program (AP) server for receiving a request from said user and dispatching said request to related one of said professional computer for executing in response to said request,
wherein said authorization computer dispatches said computer workgroup in response to said sign-on information of said user, and said AP server further informs other AP server of other related computer workgroup to execute said request while said request has to access said database of said other related computer workgroup.

2. The distributed transaction processing system according to claim 1, wherein said professional computer comprises at least a download server for replying a download request.

3. The distributed transaction processing system according to claim 1, wherein said professional computer comprises at least a communication server for replying an on-time communication request or pushing an information message to said associated on-line user, in which said information message is one selected from a group consisted of an email message, a message for event notice, and a short message.

4. The distributed transaction processing system according to claim 1, wherein said authorization computer and said computer workgroup are connected via Internet.

5. The distributed transaction processing system according to claim 1, wherein said authorization computer and said computer workgroup are connected via Intranet.

6. The distributed transaction processing system according to claim 1, wherein said computer workgroups are connected with each other via Internet.

7. The distributed transaction processing system according to claim 1, wherein said computer workgroup is connected with another computer workgroup via Intranet.

8. The distributed transaction processing system according to claim 1, wherein said authorization computer further comprises a Sign-on, Identify and Authorize module for identifying said sign-on information of said user.

9. The distributed transaction processing system according to claim 1, wherein said authorization computer further comprises a dispatch module for dispatching said request to related one of said professional computer.

10. The distributed transaction processing system according to claim 1, wherein said database, said professional sever and said AP server further comprises a Data Encode and Decode module for protecting data thereof.

11. The distributed transaction processing system according to claim 1, wherein said AP server further comprises a procedure-call interface for communicating with each other.

12. A distributed transaction processing method, comprising the steps of:
a) initializing a distributed transaction processing system comprising at least a computer workgroup, wherein said computer workgroup further comprises at least a professional computer;
b) inputting a sign-on information;
c) obtaining an identifying information and a related code name of said computer workgroup according to said sign-on information;
d) verifying said identifying information with said sign-on information;
e) connecting to said computer workgroup according to said related code name thereof;
f) issuing a request; and
g) dispatching said request to said professional computer for proceeding and executing.

13. The distributed transaction processing method according to claim 12, wherein said step d) is repeated to be executed in an anticipated period.

14. The distributed transaction processing method according to claim 12, wherein said step e) further comprises the step of e1) dispatching an application-program (AP) server in response to said identifying information.

15. The distributed transaction processing method according to claim 12, further comprising the steps of:
h) connecting to another computer workgroup of said distributed transaction processing system;
i) transmitting said request to said another computer workgroup;
j) dispatching said request to a professional computer of said another computer workgroup for proceeding and executing.

16. The distributed transaction processing method according to claim 15, wherein said step h) further comprises the step of h1) dispatching an application-program (AP) server of said other computer workgroup in response to said request.

17. The distributed transaction processing method according to claim 12, wherein said identifying information and said related code name of said computer workgroup are stored in an authorization computer.

18. The distributed transaction processing method according to claim 12, wherein said step e) further comprises the step of e2) transmitting a verified result of said sign-on information and said identifying information.

19. The distributed transaction processing method according to claim 18, wherein said authorization computer further comprises a Sign-on, Identify and Authorize module for identifying said sign-on information.

20. The distributed transaction processing method according to claim 12, further comprising the step of k) replying a result information after said request has been proceeded and executed.

21. The distributed transaction processing method according to claim 20, further comprising the step of l) storing said result information into a database of said computer workgroup.
